(19) United States
(12) Patent Application Publication
(10) Pub. No.: US 2026/0178526 A1
(43) Pub. Date: Jun. 25, 2026

(54) ADAPTER CARD, MAINBOARD, COMPUTER, DATA TRANSMISSION METHOD, DEVICE, AND NON-VOLATILE READABLE STORAGE MEDIUM

(71) Applicant: SUZHOU METABRAIN INTELLIGENT TECHNOLOGY CO., LTD., Suzhou, Jiangsu (CN)

(72) Inventor: Baoming JIA, Suzhou, Jiangsu (CN)

(73) Assignee: SUZHOU METABRAIN INTELLIGENT TECHNOLOGY CO., LTD., Suzhou, Jiangsu (CN)

(21) Appl. No.: 18/879,721

(22) PCT Filed: Mar. 4, 2024
(86) PCT No.: PCT/CN2024/079967

§ 371 Date: Dec. 27, 2024

(30) Foreign Application Priority Data
Mar. 30, 2023 (CN) 202310324430.8

(51) Int. Cl. G06F 13/40; G06F 1/26; G06F 13/38

(52) U.S. Cl. CPC G06F 13/4022; G06F 1/26; G06F 1/266; G06F 13/385; G06F 13/4068

(57) ABSTRACT

The present disclosure discloses an add in card, a motherboard, a computer, a method of transmitting data, a device, and a non-volatile readable storage medium, and relates to the field of computer technology. An add in card body, and a first connector and a second connector which are arranged on the add in card body are included. A control bus transmission end of the first connector is connected with a control bus transmission end of the second connector. A data bus transmission end of the first connector is connected with a data bus transmission end of the second connector. A serial port communication end of the first connector is connected with a serial port communication end of the second connector.

### CROSS-REFERENCE TO RELATED APPLICATION

The present application is a National Stage Application of PCT International Application No.: PCT/CN2024/079967 filed on Mar. 4, 2024, which claims priority to Chinese Patent Application 202310324430.8, filed in the China National Intellectual Property Administration on Mar. 30, 2023, the disclosure of which is incorporated herein by reference in its entirety.

### TECHNICAL FIELD

The present disclosure relates to the field of computer technology, and in particular, to an add in card, a motherboard, a computer, a method of transmitting data, a device, and a non-volatile readable storage medium.

### BACKGROUND

U.2 (Universal Serial Bus, designated as SFF-8639), as a novel high-speed interface, has gradually emerged in an enterprise-level high-performance solid state drive (SSD), beginning to replace a serial ATA (SATA) interface as a mainstream high-speed interface. A U.2 solid state drive has the characteristics of high speed, low latency, and low power consumption, but may only be used after being plugged in a device with a U.2 interface, severely limiting the application scope. A current computer is only provided with a peripheral component interconnect express (PCIe, a high-speed serial computer expansion bus standard) slot interface, making it impossible to utilize the convenience offered by a U.2 interface.

Therefore, how to analyze data transmission faults between the computer and the solid state drive, as well as how to improve a data transmission rate between the computer and the solid state drive, have become pressing technical problems to be solved in the industry.

### SUMMARY

The present disclosure provides an add in card, a motherboard, a computer, a method of transmitting data, a device, and a non-volatile readable storage medium, to solve the technical problems about how to analyze data transmission faults between a computer and a solid state drive, as well as how to improve a data transmission rate between the computer and the solid state drive.

According to a first aspect, the present disclosure provides an add in card, including an add in card body, and a first connector and a second connector which are arranged on the add in card body, where the first connector is configured to connect to a computer, and the second connector is configured to connect to a hard disk;
a control bus transmission end of the first connector is connected with a control bus transmission end of the second connector, the control bus transmission end of the first connector and the control bus transmission end of the second connector are configured to transmit device control information between the computer and the hard disk;
a data bus transmission end of the first connector is connected with a data bus transmission end of the second connector, the data bus transmission end of the first connector and the data bus transmission end of the second connector are configured to transmit write data or read data between the computer and the hard disk; and
a serial port communication end of the first connector is connected with a serial port communication end of the second connector, the serial port communication end of the first connector and the serial port communication end of the second connector are configured to transmit serial port communication information, where the serial port communication information is used for fault analysis on the hard disk or the computer.

In some embodiments, the add in card body is provided with a level conversion module;
a first signal end of the level conversion module is connected with the serial port communication end of the first connector, and a second signal end of the level conversion module is connected with the serial port communication end of the second connector, the level conversion module is configured to, when a signal level of the first connector is inconsistent with a signal level of the second connector, adjust a signal level of the serial port communication information; and
a first power supply input end of the level conversion module is connected with a control power supply output end of the first connector, and is configured to acquire a first operating power supply.

In some embodiments, the add in card body is provided with a power supply conversion module; and
a power supply input end of the power supply conversion module is connected with a control power supply output end of the first connector, a power supply output end of the power supply conversion module is connected with a second power supply input end of the level conversion module, and the power supply conversion module is configured to provide a second operating power supply for the level conversion module.

In some embodiments, a driving power supply output end of the first connector is connected with a driving power supply input end of the second connector, the driving power supply output end of the first connector and the driving power supply input end of the second connector are configured to provide a driving power supply for the hard disk.

In some embodiments, the add in card body is provided with a power supply protection module; and
a first end of the power supply protection module is connected with a driving power supply output end of the first connector, and a second end of the power supply protection module is connected with a driving power supply input end of the second connector, the power supply protection module is configured to perform power supply protection on the hard disk, wherein the power supply protection includes at least one of overvoltage protection, overcurrent protection, and undervoltage protection.

In some embodiments, the add in card body is provided with a first signal light;
a power supply input end of the first signal light is connected with a driving power supply output end of the first connector, and a power supply output end of the first signal light is connected with a grounding terminal of the add in card, the first signal light is configured to indicate a power supply state of the driving power supply.

In some embodiments, the add in card body is provided with a second signal light; and
a power supply input end of the second signal light is connected with a control power supply output end of the first connector, and a power supply output end of the second signal light is connected with a state indication end of the second connector, the second signal light is configured to indicate an operation state of the hard disk.

In some embodiments, the add in card body is provided with a third signal light; and
a power supply input end of the third signal light is connected with a control power supply output end of the first connector, and a power supply output end of the third signal light is connected with the grounding terminal of the add in card, the third signal light is configured to indicate a power supply state of the control power supply.

In some embodiments, the add in card body is provided with a function configuration module; and
the function configuration module is connected with a hard disk control end of the second connector, and the function configuration module is configured to configure hardware functions of the hard disk.

In some embodiments, a control power supply output end of the first connector is connected with the function configuration module, and the control power supply output end of the first connector is configured to provide a control power supply for the function configuration module.

In some embodiments, the function configuration module includes a port selection unit; and
a power supply input end of the port selection unit is connected with a control power supply output end of the first connector, and a power supply output end of the port selection unit is connected with a hard disk port selection end of the second connector, and the port selection unit is configured to determine a port mode for connecting the hard disk to the computer; and the port mode includes a single-port mode or a dual-port mode.

In some embodiments, the function configuration module includes a hard disk enable unit; and
a power supply input end of the hard disk enable unit is connected with the control power supply output end of the first connector, and a power supply output end of the hard disk enable unit is connected with a hard disk enable end of the second connector, and the hard disk enable unit is configured to control the hard disk to enter an operation state.

In some embodiments, the add in card body is provided with a serial port debug module; and
a signal transmission end of the serial port debug module is connected with the serial port communication end of the first connector, the serial port debug module is configured to export the serial port communication information and debug the computer or the hard disk.

In some embodiments, the level conversion module comprises a transistor;
a source electrode of the transistor is connected to the second operating power supply, and connected with the serial port communication end of the second connector;
a gate electrode of the transistor is connected to the second operating power supply; and
a drain electrode of the transistor is connected to the first operating power supply, and connected with the serial port communication end of the first connector.

According to a second aspect, the present disclosure provides a motherboard, including an add in card, a slot, and a solid state drive;
wherein the slot is arranged on the motherboard;
the add in card is arranged in the slot in a pluggable manner; and
the solid state drive is arranged on the add in card in a pluggable manner.

According to a third aspect, the present disclosure provides a computer, including a case and a motherboard, wherein the motherboard is arranged in the case.

According to a fourth aspect, the present disclosure provides a method of transmitting data, applied to a computer, including:
receiving a data writing instruction and written data;
generating a writing control signal based on the data writing instruction;
sending the writing control signal to a solid state drive based on an add in card;
receiving writing state feedback information sent by the solid state drive based on the writing control signal; and
sending the written data to the solid state drive based on the add in card.

In some embodiments, the method further includes:
receiving a data reading instruction and a data storage address;
generating a reading control signal based on the data reading instruction;
sending the reading control signal to the solid state drive based on the add in card;
receiving reading state feedback information sent by the solid state drive based on the reading control signal;
sending the data storage address to the solid state drive based on the add in card; and
receiving reading data sent by the solid state drive.

In some embodiments, the method further includes:
acquiring an exception log sent by the serial port debug module of the add in card;
parsing the exception logs to determine read-write fault information of the add in card;
determining a fault repair program based on the read-write fault information; and
sending the fault repair program to the serial port debug module to debug the solid state drive connected to the add in card.

According to a fifth aspect, the present disclosure provides an electronic device, including a memory, a processor, and a computer program stored on the memory and running on the processor, and the processor, when executing the program, implements the method of transmitting data according to the first aspect.

According to a sixth aspect, the present disclosure provides a non-volatile readable storage medium, having a computer program stored therein. The computer program, when executed by the processor, implements the method of transmitting data according to the first aspect.

According to the add in card, the motherboard, the computer, the method of transmitting data, the device, and the non-volatile readable storage medium provided in the present disclosure, the PCIe connector and the U.2 connector arranged on the add in card body are included. By connecting the control bus transmission end of the PCIe connector with the control bus transmission end of the U.2 connector, and connecting the data bus transmission end of the PCIe connector with the data bus transmission end of the U.2 connector, the device control information and the data are respectively transmitted; and the serial port communication end of the PCIe connector is connected with the serial port communication end of the U.2 connector, and the serial port communication end of the PCIe connector and the serial port communication end of the U.2 connector are configured to perform fault analysis on the hard disk or the computer. The add in card may not only allow the computer without a U.2 interface to conveniently connect to the solid state drive with the U.2 interface, expanding the data storage capacity of the computer and improving the data read and write rate of the computer, but also enable the export of the serial port communication information for data transmission fault analysis. Additionally, the add in card is connected with the computer and the hard disk in a pluggable manner, thereby enhancing the convenience of expanding the computer storage capacity.

### BRIEF DESCRIPTION OF THE DRAWINGS

The accompanying drawings herein are incorporated into the specification to form a part of the specification, illustrate embodiments conforming to the present disclosure, and are used to explain the principle of the present disclosure together with the specification.

In order to describe technical solutions in the embodiments of the present disclosure or in the prior art more clearly, the accompanying drawings required to be used in descriptions of the embodiments or the prior art will be briefly introduced below, it is apparent that the accompanying drawings described below are only some embodiments of the present disclosure, and those of ordinary skill in the art may also obtain other accompanying drawings according to these accompanying drawings without creative work.

FIG. 1 is a first schematic diagram of a structure of an add in card according to the present disclosure;

FIG. 2 is a second schematic diagram of a structure of an add in card according to the present disclosure;

FIG. 3 is a third schematic diagram of a structure of an add in card according to the present disclosure;

FIG. 4 is a fourth schematic diagram of a structure of an add in card according to the present disclosure;

FIG. 5 is a fifth schematic diagram of a structure of an add in card according to the present disclosure;

FIG. 6 is a sixth schematic diagram of a structure of an add in card according to the present disclosure;

FIG. 7 is a seventh schematic diagram of a structure of an add in card according to the present disclosure;

FIG. 8 is an eighth schematic diagram of a structure of an add in card according to the present disclosure;

FIG. 9 is a principle diagram of a circuit protection module according to the present disclosure;

FIG. 10 is a principle diagram of a power supply conversion module according to the present disclosure;

FIG. 11 is a principle diagram of a signal level conversion module according to the present disclosure;

FIG. 12 is a schematic diagram of a structure of a motherboard according to the present disclosure;

FIG. 13 is a schematic diagram of a structure of a computer according to the present disclosure;

FIG. 14 is a schematic flowchart of a method of transmitting data according to the present disclosure; and

FIG. 15 is a schematic diagram of a structure of an electronic device according to the present disclosure.

### DETAILED DESCRIPTION OF THE EMBODIMENTS

In order to make those skilled in the art better understand solutions of the present disclosure, the technical solutions in the embodiments of the present disclosure are clearly and completely described in conjunction with the accompanying drawings in the embodiments of the present disclosure as below, and it is apparent that the described embodiments are merely a part rather all the embodiments of the present disclosure. Based on the embodiments of the present disclosure, other embodiments obtained by those of ordinary skill in the art without creative labor shall fall within the scope of protection of the present disclosure.

It should be noted that the terms such as “first” and “second” of the present disclosure are used to distinguish similar objects but are not necessarily intended to describe specific sequences or precedence orders. It should be understood that such used data is interchangeable where appropriate, such that the embodiments of the present disclosure described herein may be implemented in an order other than those illustrated or described herein. In addition, the terms “include”, “have”, and any variations thereof are intended to encompass non-exclusive inclusions. For example, a process, a method, a system, a product, or a device including a series of steps or units is not necessarily limited to those explicitly-listed steps or units, but may include other steps or units that are not explicitly listed or inherent to the process, the method, the system, the product, or the device.

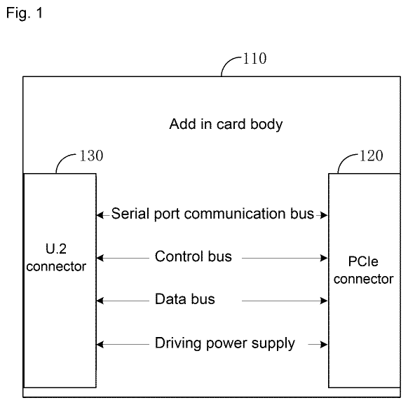

FIG. 1 is a first schematic diagram of a structure of an add in card according to the present disclosure. As shown in FIG. 1, the add in card includes: an add in card body 110, and a PCIe connector 120 (a first connector) and a U.2 connector 130 (a second connector) which are arranged on the add in card body 110. The PCIe connector is configured to connect to a computer, and the U.2 connector is configured to connect to a hard disk.

A control bus transmission end of the PCIe connector 120 is connected with a control bus transmission end of the U.2 connector 130, the control bus transmission end of the PCIe connector 120 and the control bus transmission end of the U.2 connector 130 are configured to transmit device control information between the computer and the hard disk.

A data bus transmission end of the PCIe connector 120 is connected with a data bus transmission end of the U.2 connector 130, the data bus transmission end of the PCIe connector 120 and the data bus transmission end of the U.2 connector 130 are configured to send written data to the hard disk or receive read data sent by the hard disk.

A serial port communication end of the PCIe connector 120 is connected with a serial port communication end of the U.2 connector 130, the serial port communication end of the PCIe connector 120 and the serial port communication end of the U.2 connector 130 are configured to transmit serial port communication information, and the serial port communication information is configured to perform a fault analysis on the hard disk or the computer.

A driving power supply output end of the PCIe connector 120 is connected with a driving power supply input end of the U.2 connector 130, and the driving power supply output end of the PCIe connector 120 and the driving power supply input end of the U.2 connector 130 are configured to provide a driving power supply for the hard disk.

In embodiments of present disclosure, above PCIe connector may be an example of the first connector, and above U.2 connector may be example of the second connector.

Optionally, peripheral component interconnect express (PCIe) is a high-speed serial computer expansion bus standard, and has the advantages of a high data transmission speed, strong anti-interference, a long transmission distance, and low power consumption. U.2 is an interface specification applied to the solid state drive, and has a high data transmission speed, a small interface size, support for an NVM express (NVMe, a non-volatile memory host controller interface specification) standard, support for a SATA-express specification, and compatibility with specifications such as serial attached SCSI (SAS), and SATA.

The add in card provided in the present disclosure is configured to connect a computing device with a PCIe slot and a storage device with a U.2 interface. The computing device may include a portable computer, a desktop computer, a server, a smart terminal, etc. The storage device mainly refers to the solid state drive, etc.

The add in card body 110 of the add in card may be a printed circuit board (PCB). A surface of the PCB is provided with a circuit, the surface of the PCB may be configured to install electronic components and achieve mutual connection between the electronic components through a copper wire.

The add in card body 110 may be provided with the PCIe connector 120 and the U.2 connector 130. The PCIe connector 120 is connected with the PCIe slot of the computer, the U.2 connector 130 is connected with the hard disk, and the two connectors may be arranged on two sides of the add in card body 110 respectively to provide a spatial position for connection between the computer and the hard disk.

Since the computer is typically provided with the PCIe slot, the PCIe connector 120 may be selected as a PCIe plug (a connecting finger, known as a golden finger), so as to achieve matched plug-in with the computer.

The U.2 connector arranged on the hard disk is typically a U.2 male connector, and correspondingly, the U.2 connector 130 on the add in card may be a U.2 female connector. Through the arrangement, the add in card may be in plug-in fit with the hard disk.

The control bus transmission end of the PCIe connector 120 is connected with the control bus transmission end of the U.2 connector 130, the control bus transmission end of the PCIe connector 120 and the control bus transmission end of the U.2 connector 130 are configured to transmit the device control information between the computer and the hard disk. The device control information refers to control information related to the device, including power control information, device attribute information, etc.

A control bus herein may be a system management bus (SMbus). For example, the control bus transmission end may be an SMBCLK (a clock line) pin and an SMBDAT (a data line) pin in the PCIe plug. Using the SMBus, messages are sent and received between the computer and the hard disk through the SMBus, without using separate control lines, thereby reducing the number of device pins. The hard disk may also provide information such as production information, a model number, and a component number. For a suspend event, the state of the hard disk is saved, different types of errors are reported, control parameters are received, and the state of the hard disk is returned.

The data bus transmission end of the PCIe connector 120 is connected with the data bus transmission end of the U.2 connector 130, the data bus transmission end of the PCIe connector 120 and the data bus transmission end of the U.2 connector 130 are configured to send the written data to the hard disk or receive the read data sent by the hard disk. A data bus herein is a PCIe bus, and is configured to transmit data between the computer and the hard disk. The data includes two parts: one part is the write data processed by the computer that needs to be written to the hard disk, and the other part is the read data read from the hard disk that needs to be sent to the computer for processing.

The number of data bus transmission ends may be selected according to the type of the PCIe plug. For example, when the PCIe plug is a PCIe X1 plug, the data bus transmission end may be selected as a channel 0; when the PCIe plug is a PCIe X4 plug, the data bus transmission ends may be selected as channels 0 to 3; when the PCIe plug is a PCIe X8 plug, the data bus transmission ends may be selected as channels 0 to 7; and when the PCIe plug is a PCIe X16 plug, the data bus transmission ends may be selected as channels 0 to 15.

To ensure stable operation of the solid state drive, it is also necessary to provide the driving power supply to the solid state drive. The driving power supply is configured to provide an operating power supply to the solid state drive, such that various electronic components in the solid state drive may operate, and under the control of the computer, data read, write, and storage are achieved.

Therefore, the driving power supply output end of the PCIe connector 120 is connected with the driving power supply input end of the U.2 connector 130, and the driving power supply output end of the PCIe connector 120 and the driving power supply input end of the U.2 connector 130 are configured to provide the driving power supply for the hard disk.

On the add in card body, a control bus wire, a data bus wire, and a power wire may be laid through an electronic printing technology, thereby improving reliability of signal transmission.

In the data transmission process between the computer and the hard disk, data transmission faults may occur. The computer or the hard disk may generate exception logs, etc., which is manifested in the manner of the serial port communication information. By analyzing these exception logs, the causes of the data transmission faults may be analyzed, thereby facilitating troubleshooting.

Additionally, information for troubleshooting may also be presented in the manner of the serial port communication information. For example, a debug signal or a debug program may be sent to the computer or the hard disk in the manner of the serial port communication information, thereby eliminating the data transmission faults.

The add in card provided in this embodiment of the present disclosure includes the PCIe connector and the U.2 connector arranged on the add in card body. By connecting the control bus transmission end of the PCIe connector with the control bus transmission end of the U.2 connector, and connecting the data bus transmission end of the PCIe connector with the data bus transmission end of the U.2 connector, the device control information and the data are respectively transmitted; and the serial port communication end of the PCIe connector is connected with the serial port communication end of the U.2 connector, and the serial port communication end of the PCIe connector and the serial port communication end of the U.2 connector are configured to perform fault analysis on the hard disk or the computer. The add in card may not only allow the computer without the U.2 interface to conveniently connect to the solid state drive with the U.2 interface, expanding the data storage capacity of the computer and improving a data read and write rate of the computer, but also enable the export of the serial port communication information for data transmission fault analysis. Additionally, the add in card is connected with the computer and the hard disk in a pluggable manner, thereby enhancing the convenience of expanding the computer storage capacity. In some embodiments, the serial port communication information includes a first serial port communication information and a second serial port communication information.

The serial port communication end of the PCIe connector is connected with the serial port communication end of the U.2 connector, the serial port communication end of the PCIe connector and the serial port communication end of the U.2 connector are configured to send the first serial port communication information to the hard disk and receive the second serial port communication information sent by the hard disk.

Optionally, the computer connected with the PCIe connector and the hard disk connected with the U.2 connector may also be in asynchronous communication through a universal synchronous receiver/transmitter (UART).

A serial communication wire may be arranged on the add in card body of the add in card to connect the serial port communication end of the PCIe connector with the serial port communication end of the U.2 connector, thereby causing the computer to send the first serial port communication information to the hard disk through the serial port communication end, or to receive the second serial port communication information sent by the hard disk.

In some embodiments, the add in card body is provided with a level conversion module.

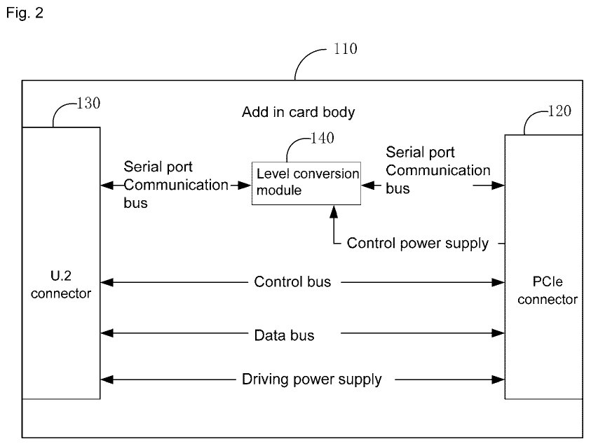

FIG. 2 is a second schematic diagram of a structure of an add in card according to the present disclosure. As shown in FIG. 2, a first signal end of the level conversion module 140 is connected with the serial port communication end of the PCIe connector 120, and a second signal end of the level conversion module 140 is connected with the serial port communication end of the U.2 connector 130, the level conversion module 140 is configured to, when a signal level of the PCIe connector is inconsistent with a signal level of the U.2 connector, adjust a signal level of the first serial port communication information or the second serial port communication information.

A first power supply input end of the level conversion module 140 is connected with a control power supply output end of the PCIe connector 120, the first power supply input end of the level conversion module 140 and the control power supply output end of the PCIe connector 120 are configured to acquire a first operating power supply.

Optionally, due to the variety of level standards used by the UART, when the serial port communication information is sent between the computer and the hard disk, the signal levels used by the two connectors may be inconsistent.

Therefore, the level conversion module may be arranged on the add in card body. The first signal end of the level conversion module is connected with the serial port communication end of the PCIe connector, and the second signal end of the level conversion module is connected with the serial port communication end of the U.2 connector.

When the signal level of the PCIe connector is inconsistent with the signal level of the U.2 connector, the level conversion module modulates the signal level of the serial port communication information. For example, when the computer sends the first serial port communication information to the hard disk, the signal level of the PCIe connector is higher than that of the U.2 connector, and the level conversion module performs voltage reduction processing on the signal level of the first serial port communication information; and when the hard disk sends the second serial port communication information to the computer, the signal level of the U.2 connector is lower than that of the PCIe connector, and the level conversion module performs voltage boost processing on the signal level of the second serial port communication information.

The first power supply input end of the level conversion module is connected with the control power supply output end of the PCIe connector, and the level conversion module is configured to acquire the first operating power supply from the PCIe slot of the computer.

In some embodiments, the add in card body is provided with a power supply conversion module.

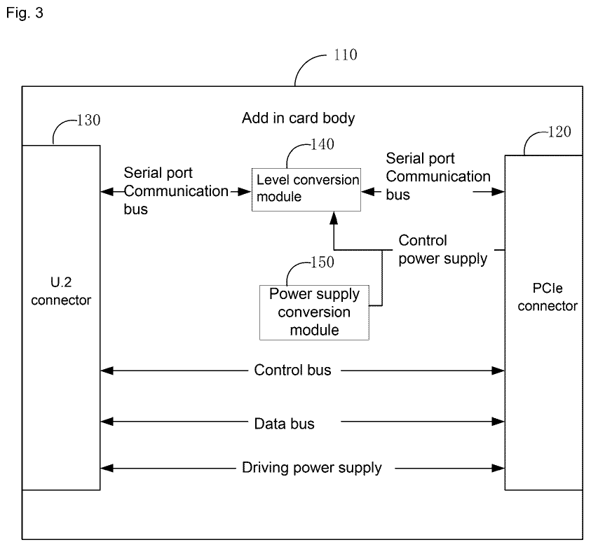

FIG. 3 is a third schematic diagram of a structure of an add in card according to the present disclosure. As shown in FIG. 3, a power supply input end of the power supply conversion module 150 is connected with a control power supply output end of the PCIe connector 120, and a power supply output end of the power supply conversion module 150 is connected with a second power supply input end of the level conversion module 140, and the power supply conversion module is configured to provide a second operating power supply for the level conversion module 140.

Optionally, when operating, the level conversion module may require operating power supplies of other voltage levels. Therefore, the power supply conversion module may be arranged on the add in card body. The power supply input end of the power supply conversion module is connected with the control power supply output end of the PCIe connector, and the power supply conversion module is configured to acquire a control power supply from the PCIe slot of the computer and perform voltage conversion, thereby obtaining the second operating power supply that meets requirements of the level conversion module, and then transmitting the second operating power supply to the second power supply input end of the level conversion module through the power supply output end.

In some embodiments, the add in card body is provided with a power supply protection module.

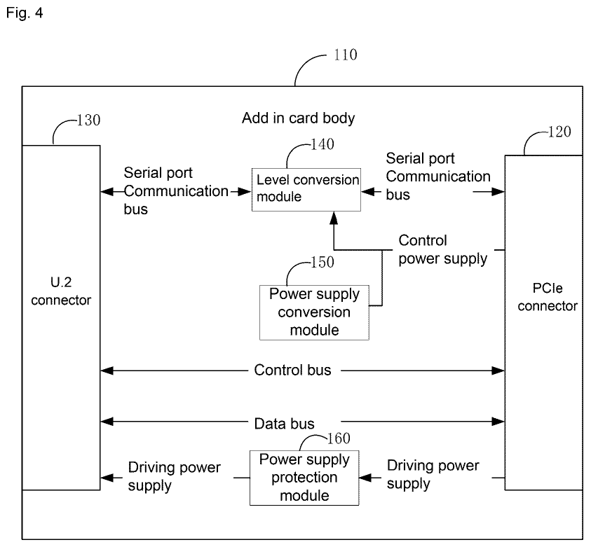

FIG. 4 is a fourth schematic diagram of a structure of an add in card according to the present disclosure. As shown in FIG. 4, a first end of the power supply protection module 160 is connected with a driving power supply output end of the PCIe connector 120, and a second end of the power supply protection module 160 is connected with a driving power supply input end of the U.2 connector 130, the power supply protection module 160 is configured to perform power supply protection on the hard disk; and the power supply protection includes at least one of overvoltage protection, overcurrent protection, and undervoltage protection.

Optionally, during operation after the computer and the hard disk are connected, to avoid damage to the electronic components, etc. in the connector, the add in card body, and the hard disk due to high inrush currents and voltage transients, the power supply protection module may be arranged on the add in card body. The first end of the power supply protection module is connected with the driving power supply output end of the PCIe connector, and the second end is connected with the driving power supply input end of the U.2 connector, thereby providing overvoltage protection, overcurrent protection, and undervoltage protection for the hard disk.

In some embodiments, the add in card body is provided with signal lights.

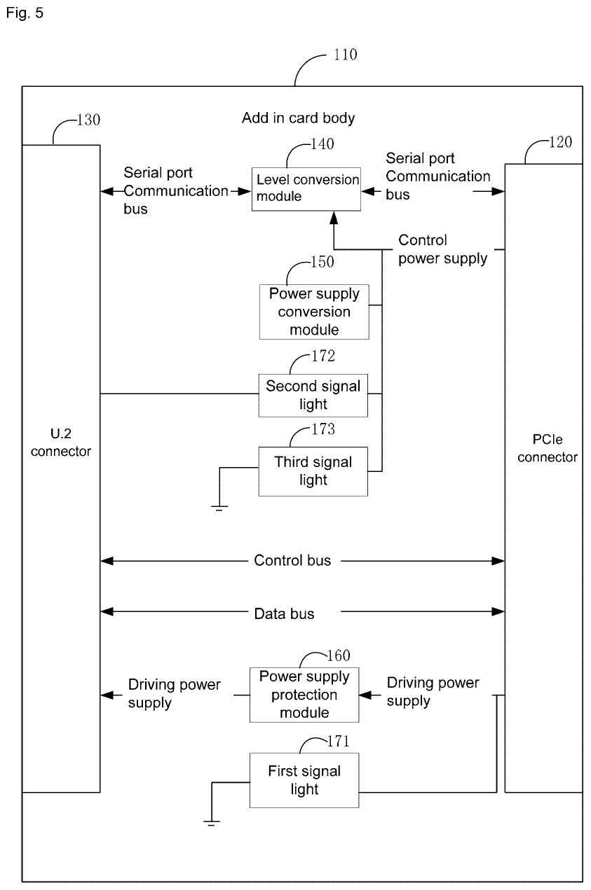

FIG. 5 is a fifth schematic diagram of a structure of an add in card according to the present disclosure. As shown in FIG. 5, the signal lights include a first signal light 171, a second signal light 172, and a third signal light 173.

A power supply input end of the first signal light 171 is connected with a driving power supply output end of the PCIe connector 120, and a power supply output end of the first signal light 171 is connected with a grounding terminal of the add in card, the first signal light 171 is configured to indicate a power supply state of the driving power supply.

A power supply input end of the second signal light 172 is connected with a control power supply output end of the PCIe connector 120, and a power supply output end of the second signal light 172 is connected with a state indication end of the U.2 connector 130, the second signal light 172 is configured to indicate an operation state of the hard disk.

A power supply input end of the third signal light 173 is connected with a control power supply output end of the PCIe connector 120, and a power supply output end of the third signal light 173 is connected with the grounding terminal of the add in card, the third signal light 173 is configured to indicate a power supply state of the control power supply.

Optionally, the signal lights may be light-emitting diodes (LEDs). The signal lights may be different in color.

The first signal light is mainly configured to indicate the power supply state of the driving power supply, and may be red. When the signal light is on, it indicates that the driving power supply is normal; and when the signal light is off, it indicates an abnormality in the driving power supply.

The second signal light is mainly configured to indicate the operation state of the hard disk, and may be green. When the signal light is on or blinking, it indicates that the hard disk is reading or writing data, it may be considered that the computer is operating on the hard disk (PCIe_ACTIVE). When the signal light is off, it indicates that the hard disk is in an idle state.

The third signal light is mainly configured to indicate the power supply state of the control power supply, and may be yellow. When the signal light is on, it indicates that the control power supply is normal; and when the signal light is off, it indicates an abnormality in the control power supply.

In some embodiments, the add in card body is provided with a function configuration module.

The function configuration module is connected with a hard disk control end of the U.2 connector, and the function configuration module is configured to configure hardware functions of the hard disk.

The control power supply output end of the PCIe connector is connected with the function configuration module, and the control power supply output end of the PCIe connector is configured to provide the control power supply for the function configuration module.

Optionally, for the hard disk, there are usually option settings reserved for the hardware functions. These option settings are implemented based on an external selection circuit. Therefore, the add in card body of the add in card may be provided with the function configuration module. A power supply input end of the function configuration module is connected with the control power supply output end of the PCIe connector, and the power supply input end of the function configuration module is configured to acquire the control power supply from the PCIe slot of the computer.

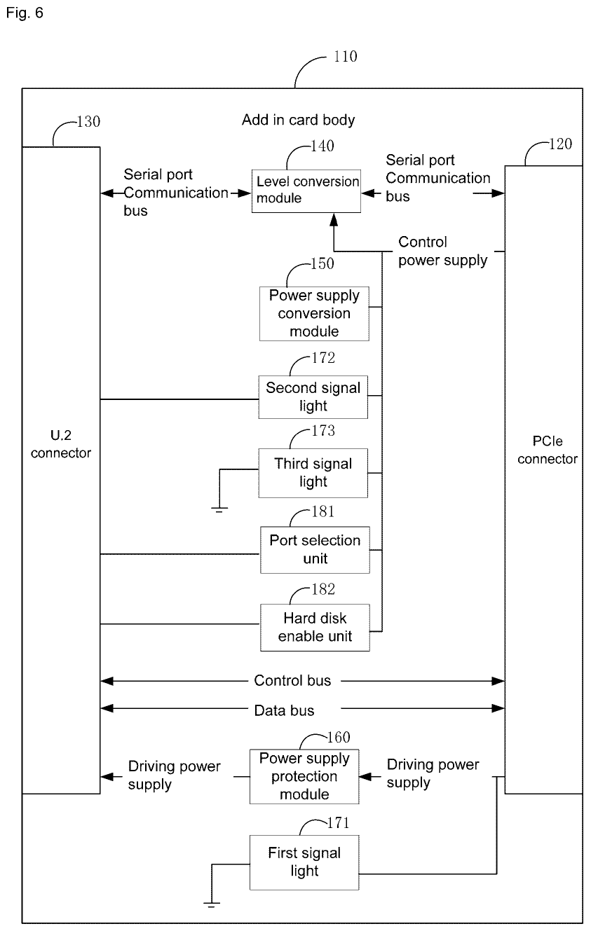

FIG. 6 is a sixth schematic diagram of a structure of an add in card according to the present disclosure. As shown in FIG. 6, the function configuration module includes a port selection unit 181 and a hard disk enable unit 182.

A power supply input end of the port selection unit 181 is connected with the control power supply output end of the PCIe connector 120, and a power supply output end of the port selection unit 181 is connected with a hard disk port selection end of the U.2 connector 130, and the port selection unit is configured to generate a port selection signal according to a user selection, and determining a port mode for connecting the hard disk to the computer.

The port mode includes a single-port mode or a dual-port mode. The solid state drive may be connected to the computer through a single port or dual ports. The dual ports may provide redundancy in the case of link disconnection or port fault.

A power supply input end of the hard disk enable unit 182 is connected with the control power supply output end of the PCIe connector 120, and a power supply output end of the hard disk enable unit 182 is connected with a hard disk enable end of the U.2 connector 130, and the hard disk enable unit 182 is configured to generate a hard disk enable signal according to a user selection, and control the hard disk to enter the operation state.

In some embodiments, the add in card body is provided with a serial port debug module.

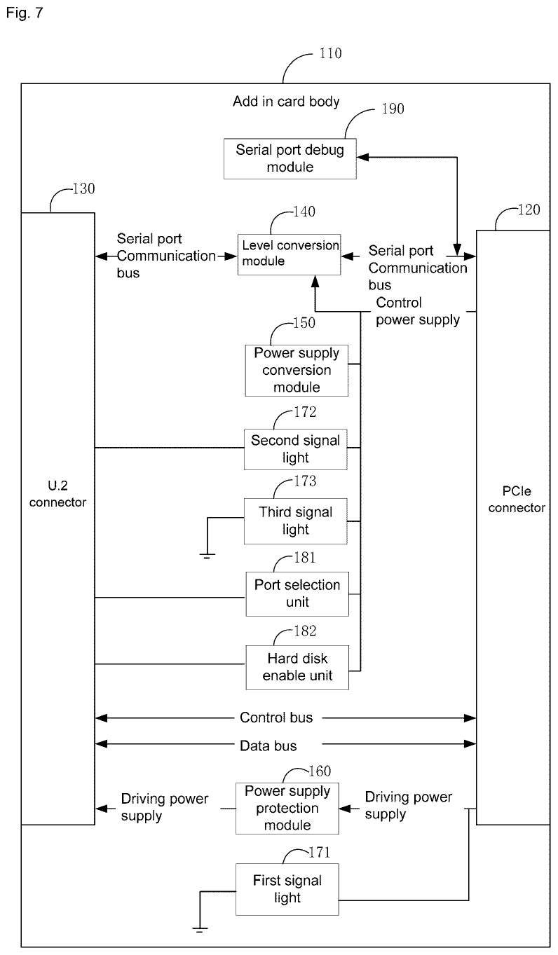

FIG. 7 is a seventh schematic diagram of a structure of an add in card according to the present disclosure. As shown in FIG. 7, a signal transmission end of the serial port debug module 190 is connected with the serial port communication end of the PCIe connector 120, and is configured to export the first serial port communication information or the second serial port communication information and debug the computer or the hard disk.

Optionally, the serial port debug module is configured to export the first serial port communication information or the second serial port communication information when the add in card malfunctions, and analyze the cause of the abnormality without acquiring the serial port communication information through the computer. Online debug may also be performed on the computer or the hard disk through the serial port debug module without detaching the hard disk or the add in card, thereby improving troubleshooting convenience.

In some embodiments, the level conversion module includes a MOS transistor.

A source electrode of the MOS transistor is connected to the second operating power supply, and connected with the serial port communication end of the U.2 connector;
a gate electrode of the MOS transistor is connected to the second operating power supply; and
a drain electrode of the MOS transistor is connected to the first operating power supply, and connected with the serial port communication end of the PCIe connector.

In embodiments of present disclosure, the transistor may include a MOS transistor.

Optionally, the level conversion module may be implemented through the metal oxide semiconductor field effect transistor (MOS).

In some embodiments, ports of both the PCIe connector and the U.2 connector support the same version of PCIe protocol; and the PCIe protocol at least includes a PCIe 5.0 protocol.

Optionally, the ports of both the PCIe connector and the U.2 connector may be designed using the same version of PCIe protocol, thereby allowing the add in card to support the computer and the hard disk of the version. The PCIe protocol may include a PCIe 5.0 protocol, a PCIe 4.0 protocol, a PCIe 3.0 protocol, a PCIe 2.0 protocol, and a PCIe protocol.

FIG. 8 is an eighth schematic diagram of a structure of an add in card according to the present disclosure. As shown in FIG. 8, an add in card (AIC) body, a U.2 female connector, and a PCIe X8 golden finger (a connector) are included. An adapter is configured to connect the computer (a PCIe device) and the solid state drive (SSD). In the figure, ohm represents the unit of resistance, P3V3_SLOT is the control power supply of 3.3V, P12V is the driving power supply of 12V, P1V8 is a converted voltage of 1.8V, PCIE_ACTIVE N indicates that the computer is operating on the hard disk, DUALPORT EN N indicates that the hard disk selects dual ports, SSD_P12V_POWER_EN indicates that the hard disk uses the driving power supply, UART TX indicates that the UART transmits information, UART RX indicates that the UART receives the information, SSD represents the solid state drive, and P3V3_AUX represents an auxiliary signal.

The AIC body is provided with a single/dual port selection module, a UART module, a signal level conversion module, an SSD_P12V_Power enable module, a single/dual port selection (DUALPORT) module, a power supply conversion module (LDO), a circuit protection module (eFUSE), and an LED indicator module.

The single/dual port selection module, the SSD_P12V_Power enable module, and a P12V_IN_Power enable module may all achieve function switchover through jumper cap short-circuiting.

The signal level conversion module may achieve consistent levels for UART communication between the PCIe device and the SSD, and the power supply conversion module may provide a required level for the signal level conversion module.

An illuminated state of the LED indicator module in the AIC body indicates the normal power supply, where an LED1 is red, indicating the P12V power supply state, an LED2 is green, indicating the PCIe_ACTIVE signal state, and an LED3 is yellow, indicating the P3V3_SLOT power supply state.

Both the U.2 female connector and the PCIe X8 golden finger are designed using a Gen5.0 protocol, so as to support Gen5.0 SSDs and PCIe devices, thereby performing data communication through PCIe 5.0 and SMbus protocols.

The single/dual port selection module is implemented through a 3PIN connector J1, with a jumper cap used to select high or low levels. The PCIe device is powered by the P3V3_SLOT, with a high level indicating the dual-port mode and a low level indicating the single-port mode.

The SSD_P12V_Power enable module is implemented through a 3PIN connector J2.

The UART module is provided with a 4PIN connector J3, and is configured for log export and problem localization in the case of system abnormalities.

The P12V_IN_Power enable module is implemented through a 3PIN connector J4, with a jumper cap used to control the on/off of the 12V voltage for an SSD side and an AIC side.

An auxiliary (AUX) signal line may also be arranged between the U.2 female connector and the PCIe X8 golden finger and the auxiliary (AUX) signal line is configured to transmit the auxiliary signal.

The circuit protection module may adopt an SQ24806AQSC eFuse chip.

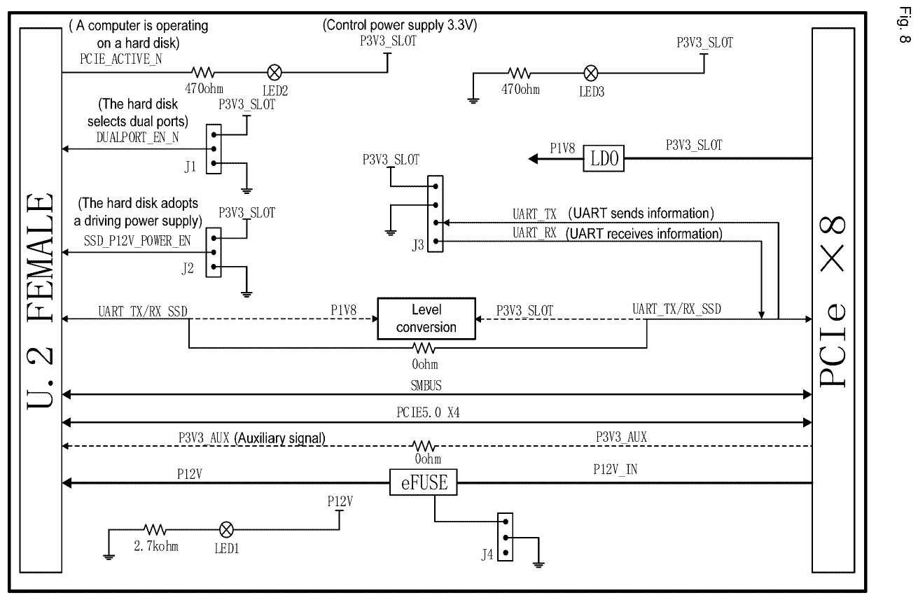

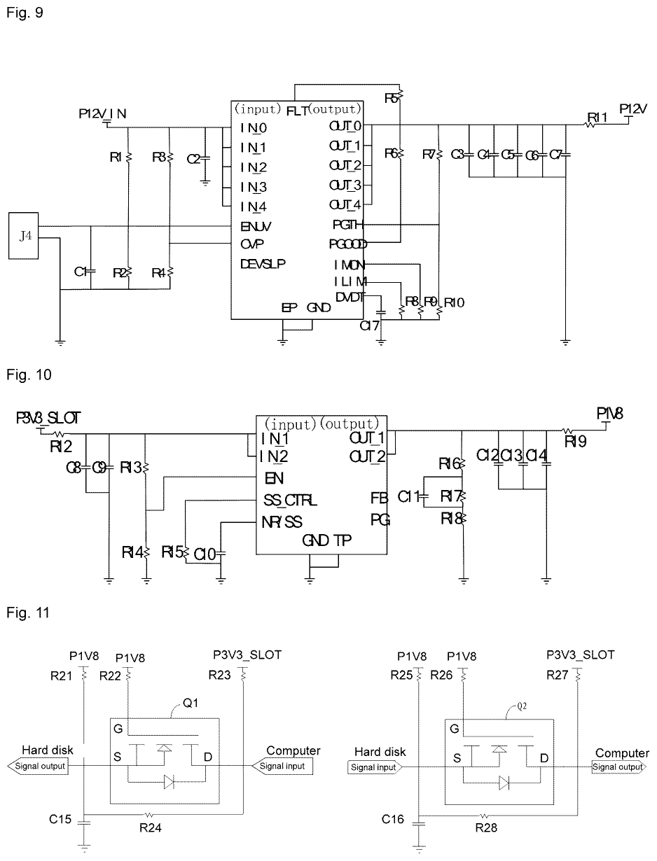

FIG. 9 is a principle diagram of a circuit protection module according to the present disclosure. As shown in FIG. 9, the 12V power supply for a hard disk side comes from the PCIe device, and is powered by the PCIe X8 golden finger. During system operation, it is inevitable to encounter cases of high inrush currents and voltage transients, to prevent damage to connectors, PCB traces, and downstream SSD components, the present disclosure uses an eFuse chip to design the circuit protection module that may provide circuit protection for abnormalities such as overvoltage, overcurrent, and undervoltage, thereby ensuring that the system remains undamaged and continues to operate safely when the abnormalities happen.

In the figure, R1 to R11 represent resistors, and C1 to C7, and C17 represent capacitors. A fault pin (FLT, used to indicate whether the eFuse chip is in a fault state), a low voltage protection enable pin (ENUV, used to activate a low voltage protection function), an overvoltage protection pin (OVP, used to detect whether an input voltage exceeds a set overvoltage protection threshold), a device sleep control pin (DEVSLP, used to control a sleep state of the device), a voltage output threshold control pin (PGTH, used to set a threshold value of an output voltage), a power good pin (PGOOD, used to indicate whether the output voltage is normal), an input current monitoring pin (IMON, used to monitor an input current), a current limit pin (ILIM, used to set a limit value of an output current), a voltage decrease time control pin (DVDT, used to set the time for the output voltage to decrease), and an external power supply control pin (EP, used to control the connection and disconnection of an external power supply) are functional pins of the eFuse chip, a GND is a ground pin of the eFuse chip, IN_0 to IN_4 are input pins of the eFuse chip, and OUT_0 to OUT_4 are output pins of the eFuse chip.

The power supply conversion module may adopt an SQ24302BSED chip.

FIG. 10 is a principle diagram of a power supply conversion module according to the present disclosure. As shown in FIG. 10, the PCIe device may only provide two fixed power supplies, the P12V and the P3V3_SLOT, to the AIC through the PCIe X8 golden finger. During the operation of low-speed signals such as the UART at the SSD side, power supplies of other levels may be needed. To ensure normal communication between the PCIe device and the SSD, it is necessary to convert a power supply needed by the SSD. Taking the P1V8 and the UART as an example in the present disclosure, the power supply conversion module and a signal level conversion module are designed, P3V3_SLOT of the PCIe device is converted into the P1V8, and level conversion between the solid state drive UART SSD and the PCIe device UART is achieved through a MOS transistor. Additionally, the signal level conversion module in the present disclosure may also be compatible with signal transmission at the same level.

In the figure, R12 to R19 represent resistors, and C8 to C14 represent capacitors. EN, SS_CTRL, NR/SS, FB, PG, and TP are functional pins of the SQ24302BSED chip, a GND is a ground pin of the chip, IN_1 and IN_2 are input pins of the chip, and OUT_1 and OUT_2 are output pins of the chip.

FIG. 11 is a principle diagram of a signal level conversion module according to the present disclosure. As shown in FIG. 11, since a UART protocol supports full-duplex communication, the signal level conversion module needs to be implemented through two MOS transistors Q1 and Q2, and after being connected in parallel, the Q1 and the Q2 are respectively connected with the U.2 female connector and the PCIe X8 golden finger. C15 to C16 represent capacitors. In the figure, G represents a gate electrode, D represents a drain electrode, and S represents a source electrode.

If the SSD side is at 1.8V and the AIC side is at 3.3V, resistors R21, R22, and R23 are to be installed in a Q1 circuit, while a resistor R24 is not to be installed; and resistors R25, R26, and R27 are to be installed in a Q2 circuit, while a resistor R28 is not to be installed.

If the AIC side and the SSD side are kept consistent in level, the resistors R21, R22, and R23 are not to be installed in the Q1 circuit, while the resistor R24 is to be installed; and the resistors R25, R26, and R27 are not to be installed in the Q2 circuit, while the resistor R28 is to be installed. In other words, there is no need to perform level conversion through MOS transistors.

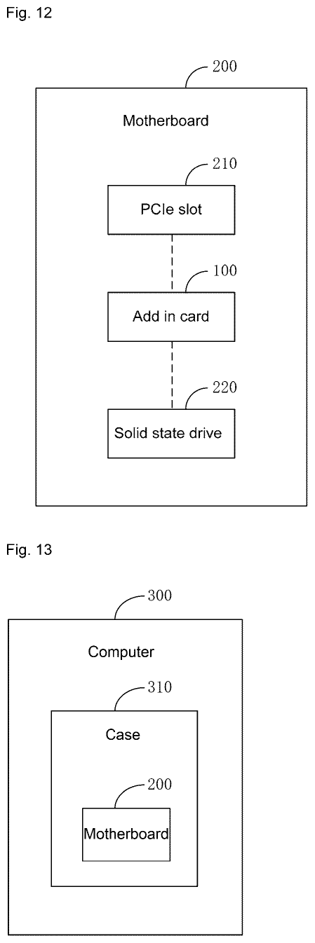

FIG. 12 is a schematic diagram of a structure of a motherboard according to the present disclosure. As shown in FIG. 12, the motherboard 200 includes the add in card 100, the PCIe slot 210, and the solid state drive 220 in the above embodiment. The PCIe slot 210 is arranged on the motherboard 200, the add in card 100 is arranged in the PCIe slot 210 in a pluggable manner, and the solid state drive 220 is arranged on the add in card 100 in a pluggable manner. Dashed lines in the figure represent a pluggable connection.

In embodiments of present disclosure, above PCIe slot may be an example of a slot.

Optionally, by using the add in card in the above embodiment, the pluggable connection of the solid state drive, the add in card, and the motherboard is achieved, thereby facilitating expansion of a storage space of the motherboard and improving the convenience of expanding the computer storage capacity.

FIG. 13 is a schematic diagram of a structure of a computer according to the present disclosure. As shown in FIG. 13, the computer 300 includes a case 310 and the motherboard 200 in the above embodiment, and the motherboard 200 is arranged in the case 310.

Optionally, the motherboard may allow the computer without a U.2 interface to conveniently connect to a solid state drive with a U.2 interface, thereby expanding the data storage capacity of the computer, and increasing a data read and write rate of the computer.

According to the computer provided in the present disclosure, the AIC with the SSD may be completely placed in the case and is fixed to the case through screws for system grounding and anti-shaking, strong anti-static and anti-interference capabilities are achieved, and the overall system stability is improved.

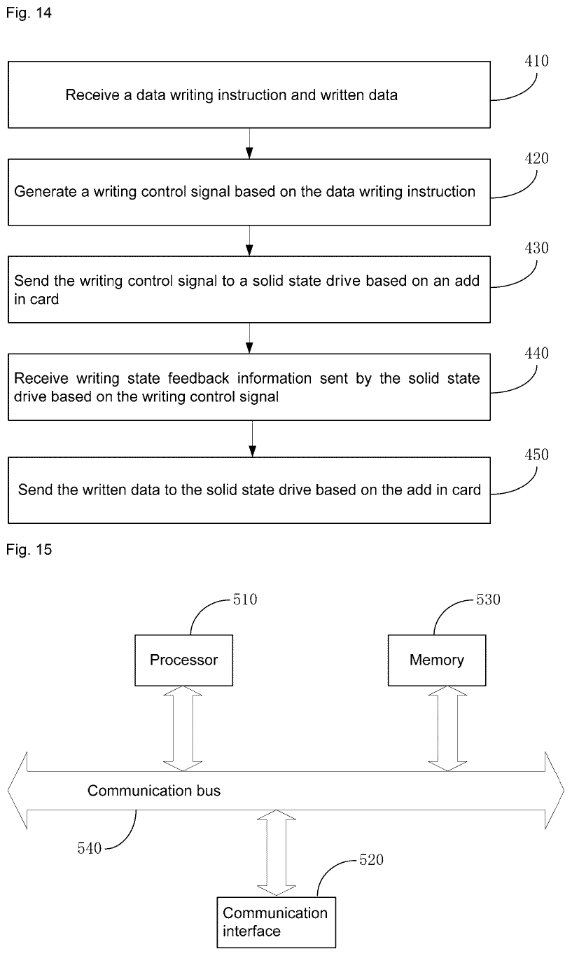

FIG. 14 is a schematic flowchart of a method of transmitting data according to the present disclosure. As shown in FIG. 14, the method includes step 410, step 420, step 430, step 440, and step 450.

Step 410: Receive a data writing instruction and written data.

Step 420: Generate a writing control signal based on the data writing instruction.

Step 430: Send the writing control signal to a solid state drive based on an add in card.

Step 440: Receive writing state feedback information sent by the solid state drive based on the writing control signal.

Step 450: Send the written data to the solid state drive based on the add in card.

Optionally, an executing entity of the data transmission method provided in this embodiment of the present disclosure is the computer in the above embodiment.

When operating the computer, the user inputs the data writing instruction and the writing data into the computer through an input device. The computer generates the writing control signal of the solid state drive according to the data written instruction. The computer sends the writing control signal to the solid state drive through the add in card.

After receiving the writing control signal, the solid state drive enters a written state, and sends the written state feedback information to the computer through the add in card.

After confirming the write state feedback information, the computer sends the written data to the solid state drive through the add in card. The solid state drive stores the written data.

For example, the PCIe X8 golden finger acquires a PCIe high-speed signal of the PCIe device, directly connects the acquired PCIe high-speed signal to a U.2 female connector interface through the PCB, and transmits the PCIe high-speed signal received by the U.2 female connector to a main controller of the solid state drive side through the U.2 connector of the SSD.

According to the data transmission method provided in this embodiment of the present disclosure, the computer without a U.2 interface may be conveniently connected to the solid state drive with a U.2 interface, thereby expanding the data storage capacity of the computer, and increasing a data read and write rate of the computer. Additionally, the add in card is connected with the computer and the hard disk in a pluggable manner, thereby enhancing the convenience of expanding the computer storage capacity.

In some embodiments, the method further includes:
receiving a data reading instruction and a data storage address;
generating a reading control signal based on the data reading instruction;
sending the reading control signal to the solid state drive based on the add in card;
receiving reading state feedback information sent by the solid state drive based on the reading control signal;
sending the data storage address to the solid state drive based on the add in card; and
receiving reading data sent by the solid state drive.

Optionally, when operating the computer, the user inputs the data reading instruction and the data storage address into the computer through the input device.

The computer generates the reading control signal of the solid state drive according to the data reading instruction. The computer sends the reading control signal to the solid state drive through the add in card.

After receiving the reading control signal, the solid state drive enters a reading state, and sends the reading state feedback information to the computer through the add in card.

After confirming the reading state feedback information, the computer sends the data storage address to the solid state drive through the add in card. The solid state drive reads the reading data stored at the data storage address, and sends the reading data to the computer.

For example, the U.2 female connector acquires a PCIe high-speed signal from the SSD, directly connects the acquired PCIe high-speed signal to the PCIe X8 golden finger through the PCB, and transmits the PCIe high-speed signal received by the PCIe X8 signal to a processor of the PCIe device.

In some embodiments, the method further includes:
acquiring an exception log sent by the serial port debug module of the add in card;
parsing the exception log to determine read-write fault information of the add in card;
determining a fault repair program based on the read-write fault information; and
sending the fault repair program to the serial port debug module to debug the solid state drive or the computer connected to the add in card.

Optionally, when the solid state drive or the computer malfunctions, the user may also acquire the exception logs sent by the serial port debug module of the add in card by connecting an external device to the serial port debug module.

The read-write fault information is obtained by analyzing these exception logs. The fault repair program may be determined according to the corresponding read-write fault information. The fault repair program may be a driver update program or a driver upgrade program, etc.

The fault repair program is sent to the serial port debug module to debug the solid state drive or the computer connected to the add in card, thereby achieving troubleshooting.

FIG. 15 is a schematic diagram of a structure of an electronic device according to the present disclosure. As shown in FIG. 15, the electronic device may include: a processor 510, a communication interface 520, a memory 530, and a communication bus 540, where the processor 510, the communication interface 520, and the memory 530 are in mutual communication through the communication bus 540. The processor 510 may invoke a logical instruction in the memory 530 to perform the method in the above embodiment, such as:
receiving a data writing instruction and written data; generating a writing control signal based on the data writing instruction; sending the writing control signal to a solid state drive based on an add in card; receiving writing state feedback information sent by the solid state drive based on the writing control signal; and sending the writing data to the solid state drive based on the add in card.

Additionally, when the logical instruction in the above memory may be implemented in the form of a software functional unit and sold or used as an independent product, the logical instruction may be stored in a non-volatile readable storage medium. Based on the understanding, the technical solutions of the present disclosure essentially, or the part contributing to the prior art, or some of the technical solutions may be embodied in the form of a software product. The computer software product is stored in the non-volatile readable storage medium and includes several instructions causing a computer device (which may be a personal computer, a server, a network device, or the like) to perform all or some of the steps of the method described in the embodiments of the present disclosure. The above non-volatile readable storage medium includes various types of non-volatile readable storage media capable of storing program code, such as a U disk, a mobile hard disk, a read-only memory (ROM), a random access memory (RAM), a magnetic disk, or an optical disc.

The processor in the electronic device provided in this embodiment of the present disclosure may invoke the logical instruction in the memory to implement the above method. An optional implementation is consistent with the above method implementation, and the same beneficial effects may be achieved, which are not elaborated herein.

An embodiment of the present disclosure further provides a computer-readable non-volatile readable storage medium, having a computer program stored therein. The computer program, when executed by a processor, implements the method provided in the above embodiments.

An optional implementation is consistent with the above method implementation, and the same beneficial effects may be achieved, which are not elaborated herein.

An embodiment of the present disclosure provides a computer program product, including a computer program. The computer program, when executed by a processor, implements the above method.

The apparatus embodiments described above are merely illustrative, units described as separate components may or may not be physically separated, and the components displayed as units may or may not be physical units, and may be located in one place or may be distributed over a plurality of network units. Some or all of the modules may be selected according to actual needs to achieve the objectives of the solution of this embodiment. Those of ordinary skill in the art may understand and implement it without creative work.

Through the descriptions of the above implementations, those skilled in the art may clearly understand that the implementations may be implemented by software in combination with a necessary universal hardware platform, and may certainly be implemented by hardware. Based on the understanding, the above technical solutions essentially or the part contributing to the prior art may be embodied in the form of a software product. The computer software product may be stored in a non-volatile readable storage medium, such as a ROM/RAM, a magnetic disk, and an optical disc, and includes several instructions causing a computer device (which may be a personal computer, a server, a network device, or the like) to perform the methods of various embodiments or some parts of the embodiments.

Finally, it should be noted that the above embodiments are merely used for illustrating rather than limiting the technical solutions of the present disclosure; although the present disclosure has been described in detail with reference to the above embodiments, those of ordinary skill in the art should understand that the technical solutions recorded in the above various embodiments may still be modified, or some of the technical features may be equivalently substituted; and such modifications or substitutions do not make the essence of the corresponding technical solutions depart from the spirit and the scope of the technical solutions of the various embodiments of the present disclosure.

1. An add in card, comprising an add in card body, and a first connector and a second connector which are arranged on the add in card body, wherein the first connector is configured to connect to a computer, and the second connector is configured to connect to a hard disk;
a control bus transmission end of the first connector is connected with a control bus transmission end of the second connector, the control bus transmission end of the first connector and the control bus transmission end of the second connector are configured to transmit device control information between the computer and the hard disk;
a data bus transmission end of the first connector is connected with a data bus transmission end of the second connector, the data bus transmission end of the first connector and the data bus transmission end of the second connector are configured to transmit written data or read data between the computer and the hard disk; and
a serial port communication end of the first connector is connected with a serial port communication end of the second connector, the serial port communication end of the first connector and the serial port communication end of the second connector are configured to transmit serial port communication information, wherein the serial port communication information is configured to perform a fault analysis on the hard disk or the computer.

2. The add in card according to claim 1, wherein the add in card body is provided with a level conversion module;
a first signal end of the level conversion module is connected with the serial port communication end of the first connector, and a second signal end of the level conversion module is connected with the serial port communication end of the second connector, the level conversion module is configured to, when a signal level of the first connector is inconsistent with a signal level of the second connector, adjust a signal level of the serial port communication information; and
a first power supply input end of the level conversion module is connected with a control power supply output end of the first connector, and the level conversion module is configured to acquire a first operating power supply.

3. The add in card according to claim 2, wherein the add in card body is provided with a power supply conversion module; and
a power supply input end of the power supply conversion module is connected with a control power supply output end of the first connector, a power supply output end of the power supply conversion module is connected with a second power supply input end of the level conversion module, and the power supply conversion module is configured to provide a second operating power supply for the level conversion module.

4. The add in card according to claim 1, wherein a driving power supply output end of the first connector is connected with a driving power supply input end of the second connector, the driving power supply output end of the first connector and the driving power supply input end of the second connector are configured to provide a driving power supply for the hard disk.

5. The add in card according to claim 1, wherein the add in card body is provided with a power supply protection module; and
a first end of the power supply protection module is connected with a driving power supply output end of the first connector, and a second end of the power supply protection module is connected with a driving power supply input end of the second connector, the power supply protection module is configured to perform power supply protection on the hard disk, wherein the power supply protection comprises at least one of overvoltage protection, overcurrent protection, and undervoltage protection.

6. The add in card according to claim 1,
wherein the add in card body is provided with a first signal light; and a power supply input end of the first signal light is connected with a driving power supply output end of the first connector, and a power supply output end of the first signal light is connected with a grounding terminal of the add in card, the first signal light is configured to indicate a power supply state of the driving power supply; and/or
the add in card body is provided with a second signal light; and a power supply input end of the second signal light is connected with a control power supply output end of the first connector, and a power supply output end of the second signal light is connected with a state indication end of the second connector, the second signal light is configured to indicate an operation state of the hard disk; and/or
the add in card body is provided with a third signal light; and a power supply input end of the third signal light is connected with a control power supply output end of the first connector, and a power supply output end of the third signal light is connected with the grounding terminal of the add in card, the third signal light is configured to indicate a power supply state of a control power supply.

7-8. (canceled)

9. The add in card according to claim 1, wherein the add in card body is provided with a function configuration module; and
the function configuration module is connected with a hard disk control end of the second connector, and the function configuration module is configured to configure hardware functions of the hard disk.

10. The add in card according to claim 9, wherein a control power supply output end of the first connector is connected with the function configuration module, and the control power supply output end of the first connector is configured to provide a control power supply for the function configuration module.

11. The add in card according to claim 9, wherein the function configuration module comprises a port selection unit; and
a power supply input end of the port selection unit is connected with a control power supply output end of the first connector, and a power supply output end of the port selection unit is connected with a hard disk port selection end of the second connector, and the port selection unit is configured to determine a port mode for connecting the hard disk to the computer; and the port mode comprises a single-port mode or a dual-port mode.

12. The add in card according to claim 9, wherein the function configuration module comprises a hard disk enable unit; and
a power supply input end of the hard disk enable unit is connected with the control power supply output end of the first connector, and a power supply output end of the hard disk enable unit is connected with a hard disk enable end of the second connector, and the hard disk enable unit is configured to control the hard disk to enter an operation state.

13. The add in card according to claim 1, wherein the add in card body is provided with a serial port debug module; and
a signal transmission end of the serial port debug module is connected with the serial port communication end of the first connector, the serial port debug module is configured to export the serial port communication information and debug the computer or the hard disk.

14. The add in card according to claim 3, wherein the level conversion module comprises a transistor;
a source electrode of the transistor is connected to the second operating power supply, and connected with the serial port communication end of the second connector;
a gate electrode of the transistor is connected to the second operating power supply; and
a drain electrode of the transistor is connected to the first operating power supply, and connected with the serial port communication end of the first connector.

15. (canceled)

16. A motherboard, comprising the add in card according to claim 1, a slot, and a solid state drive;
wherein the slot is arranged on the motherboard;
the add in card is arranged in the slot in a pluggable manner; and
the solid state drive is arranged on the add in card in a pluggable manner.

17. A computer, comprising a case and the motherboard according to claim 16, wherein the motherboard is arranged in the case.

18. A method of transmitting data, applied to the computer according to claim 17, comprising:
receiving a data writing instruction and written data;
generating a writing control signal based on the data writing instruction;
sending the writing control signal to a solid state drive based on an add in card;
receiving writing state feedback information sent by the solid state drive based on the writing control signal; and
sending the written data to the solid state drive based on the add in card.

19. The method according to claim 18, further comprising:
receiving a data reading instruction and a data storage address;
generating a reading control signal based on the data reading instruction;
sending the reading control signal to the solid state drive based on the add in card;
receiving reading state feedback information sent by the solid state drive based on the reading control signal;
sending the data storage address to the solid state drive based on the add in card; and
receiving reading data sent by the solid state drive.

20. The method according to claim 18, further comprising:
acquiring an exception log sent by a serial port debug module of the add in card;
parsing the exception log to determine read-write fault information of the add in card;
determining a fault repair program based on the read-write fault information; and
sending the fault repair program to the serial port debug module to debug the solid state drive or the computer connected to the add in card.

21. An electronic device, comprising a memory, a processor, and a computer program stored on the memory and running on the processor, wherein the program, when executed by the processor, implements the method of transmitting data according to claim 1.

22. A non-volatile readable storage medium, having a computer program stored therein, wherein the computer program, when executed by a processor, implements the method of transmitting data according to claim 1.

23. A motherboard, comprising the add in card according to claim 2, a slot, and a solid state drive;
wherein the slot is arranged on the motherboard;
the add in card is arranged in the slot in a pluggable manner; and
the solid state drive is arranged on the add in card in a pluggable manner.
